(19) United States
(12) Patent Application Publication
(10) Pub. No.: US 2014/0340322 A1
(43) Pub. Date: Nov. 20, 2014

(54) TOUCH SCREEN INPUT SYSTEM HAVING ANALOG OPERATION DEVICE

(71) Applicant: Hyundai Motor Company, Seoul (KR)

(72) Inventors: Gi Beom Hong, Bucheon (KR); Sung Un Kim, Yongin (KR); Kwang Myung Oh, Daejeon (KR); Jungsang Min, Seoul (KR)

(73) Assignee: HYUNDAI MOTOR COMPANY, Seoul (KR)

(21) Appl. No.: 14/090,790

(22) Filed: Nov. 26, 2013

(30) Foreign Application Priority Data
May 20, 2013 (KR) 10-2013-0056411

(51) Int. Cl. G06F 3/041

(52) U.S. Cl. CPC G06F 3/0416
USPC 345/173

(57) ABSTRACT

A touch screen input system has an analog operation device that is attached to a touch screen and can operate the touch screen. The touch screen input system having the analog operation device includes: a touch screen that recognizes a position of a contact point and performs a process corresponding to the position; and the analog operation device that is movably and detachably disposed on the touch screen and generates an input signal of the touch screen by coming in contact with the touch screen.

### CROSS-REFERENCE TO RELATED APPLICATION

This application claims under 35 U.S.C. §119(a) priority to and the benefit of Korean Patent Application No. 10-2013-0056411 filed in the Korean Intellectual Property Office on May 20, 2013, the entire contents of which are incorporated herein by reference.

### BACKGROUND

(a) Field of the Invention

The present invention relates to a touch screen input system having an analog operation device that is attached to a touch screen and can operate the touch screen.

(b) Description of the Related Art

In general, the center fascia of vehicles has various operation buttons.

Some of the operation buttons on the center fascia may be frequently used and others may not be frequently used, depending on particular users. That is, various types of buttons on the center fascia may or may not be familiar to certain users, depending on the experience of each user.

Further, user demand for customized vehicles keeps increasing. Accordingly, as for the GUI (Graphic User Interface), which incorporates software, a very free individual space is provided, but as for the hardware analog operation system, it is impossible to easily map individual demand and customized functions.

In particular, as new technologies are used in vehicles, an operation system (operation device) for integrated operation is required; however, in a touch screen operation system, for example, the GUI configuration can be freely and easily learned, whereas driving operations such as blind control are difficult.

In contrast, for the rotary integrated operation system generally disposed on the console in vehicles, the blind control operation is easy in driving, but the earlier learning is difficult.

Therefore, it is desirable to develop an operation system that can increase the advantages and avoid any problems of existing operation systems, that is, the touch screen operation system and the rotary integrated operation system.

The Description of the Related Art is made to help understanding the background of the present invention and may include matters out of the related art known to those skilled in the art.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a touch screen input system having an analog operation system having advantages of being able to be attached to a touch screen (or a touch interface) and to operate the touch screen. In particular, the present invention provides a touch screen input system that makes it possible to install an analog operation device on a touch screen and allows the analog operation system to input instead input signals on the touch screen.

An exemplary embodiment of the present invention provides a touch screen input system having an analog operation device, which may include: a touch screen that recognizes the position of a contact point and performs a process corresponding to the position, using corresponding software embodied in a non-transitory computer-readable medium; and the analog operation device that is movably and detachably disposed on the touch screen and generates an input signal of the touch screen by coming in contact with the touch screen in accordance with an operation.

The contact portion of the analog operation device may be made of a seesaw-shaped member with contact surfaces at both sides, which are in contact with the touch screen.

A plurality of wireless transmitters may be provided in the touch screen according to an exemplary embodiment of the present invention and a wireless receiver that receives signals from the wireless transmitters may be provided in the analog operation device.

Sliding members for sliding of the analog operation device on the touch screen may be formed on the analog operation device.

The sliding members may include elastic latches that are mounted on the sides of the touch screen and make the analog operation device movable.

Protrusions may be formed on the sides of the analog operation device and guide grooves that guide the protrusions on the analog operation device to make the analog operation device movable may be formed on the sides of the touch screen.

Guide grooves may be formed on the sides of the analog operation device and protrusions that are inserted in the guide grooves on the analog operation device to guide the analog operation device so that the analog operation device is movable may be formed on the sides of the touch screen.

Protrusion patterns for identifying specific analog operation devices on the touch screen may be formed on the bottom of the analog operation device.

A protrusion allowing a user to recognize an operation, when the user operates the contact portion, may be formed on the contact portion of the analog operation device.

As described above, according to an exemplary embodiment of the present invention, by installing an analog operation device on a touch screen so that the analog operation device can input signals instead on the touch screen, it is possible to easily achieve customization for each user.

Further, according to an exemplary embodiment of the present invention, since it is possible to appropriately combine software and operation hard keys (buttons) of a touch screen, it is possible to implement an optimum GUI (Graphic User Interface) in real time.

According to an exemplary embodiment of the present invention, it is possible to achieve an operation device that each user is familiar with, and to reduce operation recognition load through analog feedback.

According to an exemplary embodiment of the present invention, it is possible to provide a freer layout of design, and it is possible to implement a customer-fit service by arranging buttons, which are frequently used, at positions that the user can conveniently reach and operate, in accordance with the user's favor.

### BRIEF DESCRIPTION OF THE DRAWINGS

FIG. 1 is a schematic diagram of a touch screen input system having an analog operation device according to an exemplary embodiment of the present invention.

FIG. 2 is a schematic diagram of a touch screen input system having an analog operation device according to another exemplary embodiment of the present invention.

FIG. 3 is a view showing various examples of combinations of an analog operation device and a touch screen according to an exemplary embodiment of the present invention.

FIG. 4 is a view showing a sliding operation of the touch screen input system having an analog operation device according to another exemplary embodiment of the present invention.

FIG. 5 is a view showing specific identification pattern structures on the analog operation device according to an exemplary embodiment of the present invention.

### DETAILED DESCRIPTION OF THE EMBODIMENTS

Hereinafter, the present invention will be described more fully hereinafter with reference to the accompanying drawings, in which exemplary embodiments of the invention are shown. The present invention may be implemented in various ways and is not limited to the exemplary embodiments described herein.

The unrelated parts to the description of the exemplary embodiments are not shown to make the description clear and like reference numerals designate like element throughout the specification.

Further, in the following exemplary embodiments, the components having the same configuration are designated by the same reference numerals and described in the first exemplary embodiment, and only other configurations different from the first exemplary embodiment are described in the other exemplary embodiments. The size and thickness of the configurations are optionally shown in the drawings for the convenience of description and the present invention is not limited to the drawings.

Through the present specification, unless explicitly described otherwise, “including” any components will be understood to imply the inclusion of other components rather than the exclusion of any other components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

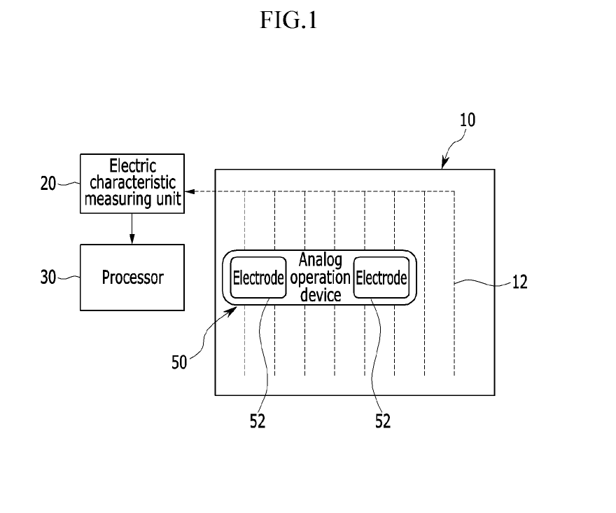

Hereinafter, a touch screen input system having an analog operation device according to exemplary embodiments of the present invention is described with reference to FIGS. 1 to 5.

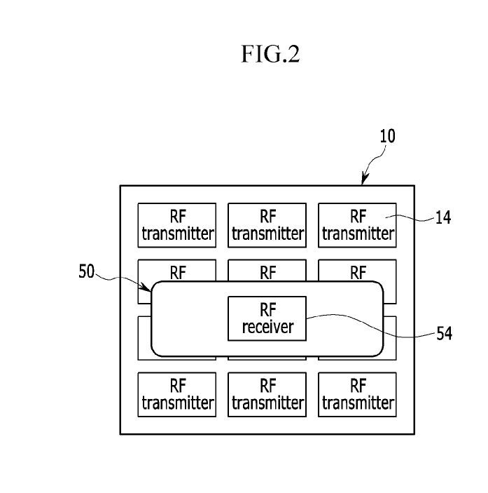

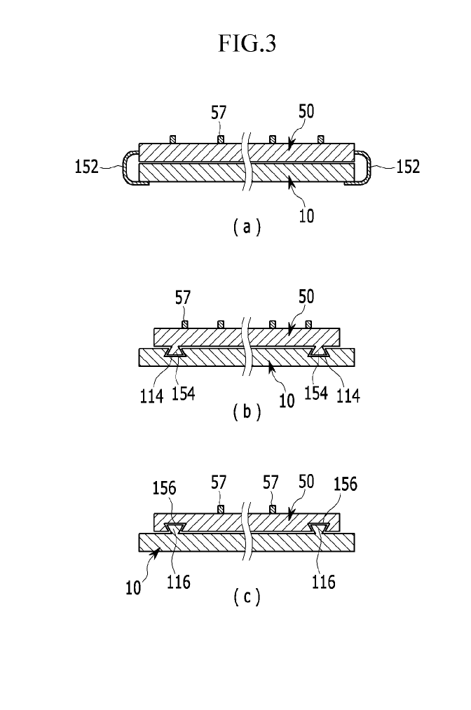

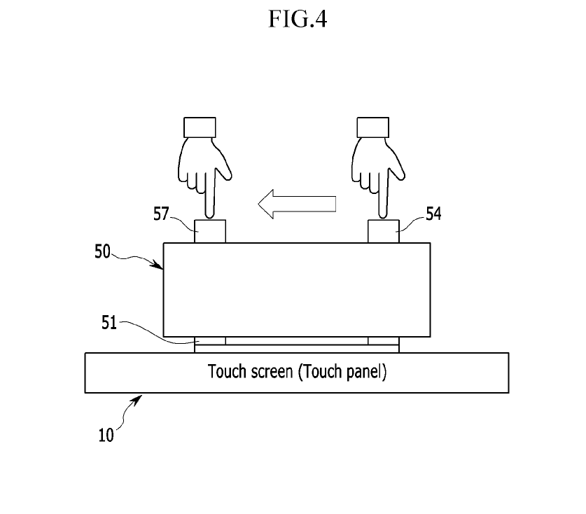

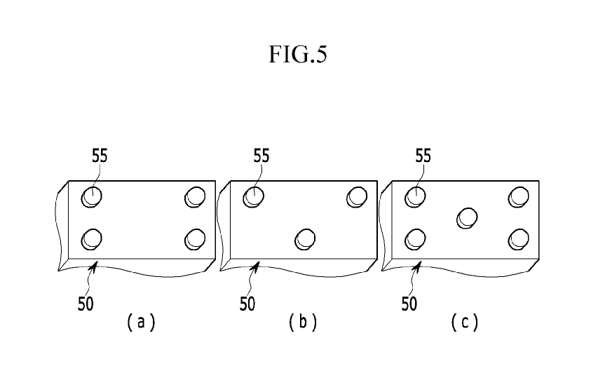

FIG. 1 is a schematic diagram of a touch screen input system having an analog operation device according to an exemplary embodiment of the present invention, FIG. 2 is a schematic diagram of a touch screen input system having an analog operation device according to another exemplary embodiment of the present invention, FIG. 3 is a view showing various examples of combination of an analog operation device and a touch screen according to an exemplary embodiment of the present invention, FIG. 4 is a view showing a sliding operation of the touch screen input system having an analog operation device according to another exemplary embodiment of the present invention, FIG. 5 is a view showing specific identification pattern structures on the analog operation device according to an exemplary embodiment of the present invention.

A touch screen input system having an analog operation device according to an exemplary embodiment of the present invention is a system that allows an analog operation system to transmit input signals to a touch screen by installing the analog operation device on the touch screen.

The touch screen input system having an analog operation device according to an exemplary embodiment of the present invention may include: a touch screen 10 that recognizes the position of a contact point and performs a process corresponding to the position, using corresponding software that is embodied in a non-transitory computer-readable medium; and an analog operation device 50 that is movably and detachably disposed on the touch screen 10 and generates an input signal of the touch screen by coming in contact with the touch screen in accordance with an operation by a user.

The touch screen 10 may be a common touch screen or touch pad that is generally used in the related art. The touch screen 10 may include an electrode 12 disposed in a predetermined pattern, as shown in the figures, an electric characteristic measuring unit 20 measuring changes in electric characteristics of the electrode 12, and a processor 30 performing a process for recognizing a touch on the touch screen on the basis of a signal from the electric characteristic measuring unit 20. Further, an electrode may be formed in a contact portion 52 on the analog operation device 50 in a predetermined pattern in order to change the characteristics of the electrode 12 of the touch screen 10.

Although the electric characteristic measuring unit 20 and the processor 30 are shown as separate components from the touch screen 10, this is for convenience of illustration, and the electric characteristic measuring unit 20 and the processor 30 may be included in the touch screen 10 as components of the touch screen 10.

The software that is executed to perform a process corresponding to the position of contact on the touch screen 10 can be stored in the processor 30, which is embodied in a non-transitory computer-readable medium, but it should not be understood that the scope of the present invention is limited only to the depicted processor, where other suitable computer components may be used.

The analog operation device 50 is slidably and detachably disposed on the touch screen 10, and for this configuration, it may include latches 152 such as those depicted in FIG. 3(a). An elastic material is preferable for the material of the latches 152 for easy combination with the touch screen 10.

When the latches 152 are loose while the analog operation device 50 slides on the touch screen 10 through the latches 152, it cannot slide well and a touch may not be inputted well to the analog operation device 50. Accordingly, by forming guide grooves 114 and 156 and protrusions 154 and 116 on the analog operation device 50 and the touch screen 10, respectively, as shown in FIGS. 3(b) and 3(c), the analog operation device 50 can smoothly slide on the touch screen 10 and can be attached/detached.

The technique of allowing the analog operation device 50 to slide on the touch screen 10 by means of the guide grooves 114 and 156 and the protrusions 154 and 116 is easy for those skilled in the art and the detailed description is not provided herein. The analog operation device 50 can slide on the touch screen 10 by the latches 152, the guide grooves 114 and 156, and the protrusions 154 and 116 and can provide a touch input through the contact portion 52 at a desired position. The contact portion 52 may be made of a seesaw-shaped member with contact surfaces 51 at both sides, which are in contact with the touch screen 10.

The technology of inputting an operation signal to the touch screen 10 by operating the contact portion 52 on the analog operation device 50, which is a separate device, can be easily achieved from the technologies disclosed in Korean Patent Application Nos. 10-2011-0018411 and 10-2010-0064219, such that the detailed description is not provided herein.

However, as shown in FIG. 2, a plurality of wireless transmitters 14 may be provided in the touch screen 10 according to an exemplary embodiment of the present invention, and a wireless receiver 54 that receives signals from the wireless transmitters 14 may be provided in the analog operation device 50. Since the wireless transmitters 14 are disposed in the touch screen 10 and the wireless receiver 54 is disposed in the analog operation device 50, as described above, a touch input can be more stably performed.

Since the analog operation device 50 is attachable/detachable on the touch screen 10, it may be formed in a structure with the contact portion 52 having various contact points. Accordingly, identification protrusion patterns 55 for identifying specific analog operation devices to be installed on the touch screen 10 may be formed on the bottom of the analog operation device 50, for example, as shown in FIG. 5(a) to (c).

The identification protrusion patterns 55, as shown in FIG. 5(a) to (c), allow the software, which is stored in the processor 30, to recognize the identification protrusion patterns 55 when they are brought in contact with the touch screen 10 and to recognize a touch input corresponding to the contact portion 52 of the analog operation device 50 having corresponding protrusion patterns 55. Therefore, according to an exemplary embodiment of the present invention, an analog operation device having various touch input structures can be achieved, such that it is possible to achieve a customized analog operation device suitable for each user.

On the other hand, a protrusion 57 that allows a user to feel an operation when the user inputs a touch by operating the contact portion 52 may be formed on the contact portion 52 of the analog operation device 50. Since the user can receive analog feedback through the protrusion 57, the user can conveniently use the analog operation device 50 without looking at the analog operation device 50.

As described above, the touch screen input system having an analog operation device according to an exemplary embodiment of the present invention can be easily used for the existing touch screens (or touch pads, touch interfaces, etc.).

In the touch screen input system having an analog operation device according to an exemplary embodiment of the present invention, since the analog operation device can be detached and separated from the touch screen in an accident, the analog operation device may be fixed to the touch screen by a magnet or Velcro to prevent the separation.

Further, in an exemplary embodiment of the present invention, it is possible to operate the analog operation device without looking at it, by providing feedback by means of voice, when operating the analog operation device.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A touch screen input system having an analog operation device, the system comprising:
a touch screen that recognizes a position of a contact point and performs a process corresponding to the position, using corresponding software embodied in a non-transitory computer-readable medium;
the analog operation device that is movably and detachably disposed on the touch screen and generates an input signal of the touch screen by coming in contact with the touch screen in accordance with an operation by a user.

2. The system of claim 1, wherein a contact portion of the analog operation device is made of a seesaw-shaped member with contact surfaces at both sides, which are in contact with the touch screen.

3. The system of claim 1, further comprising a plurality of wireless transmitters provided in the touch screen, and a wireless receiver that receives signals from the wireless transmitters provided in the analog operation device.

4. The system of claim 1, wherein sliding members for sliding of the analog operation device on the touch screen are formed on the analog operation device.

5. The system of claim 4, wherein the sliding members include elastic latches that are mounted on the sides of the touch screen and make the analog operation device movable.

6. The system of claim 1, further comprising:
protrusions formed on the sides of the analog operation device, and
guide grooves formed on the sides of the touch screen that guide the protrusions on the analog operation device to make the analog operation device movable.

7. The system of claim 1, further comprising:
guide grooves formed on the sides of the analog operation device, and
protrusions formed on the sides of the touch screen, the protrusions being inserted in the guide grooves on the analog operation device to guide the analog operation device so that the analog operation device is movable.

8. The system of claim 1, wherein protrusion patterns for identifying specific analog operation devices on the touch screen are formed on the bottom of the analog operation device.

9. The system of claim 1, wherein a protrusion allowing a user to recognize an operation, when the user operates the contact portion, is formed on the contact portion of the analog operation device.

10. A touch screen input system for a vehicle, the system comprising:
a touch screen for recognizing a position of a contact point and performs a process corresponding to the position, using corresponding software embodied in a non-transitory computer-readable medium;
an analog operation device that is movably and detachably disposed on the touch screen and generates an input signal of the touch screen by coming in contact with the touch screen in accordance with an operation by a user,
the touch screen being incorporated into a center fascia of the vehicle.

11. The system of claim 10, wherein a contact portion of the analog operation device is made of a seesaw-shaped member with contact surfaces at both sides, which are in contact with the touch screen.

12. The system of claim 10, further comprising a plurality of wireless transmitters provided in the touch screen, and a wireless receiver that receives signals from the wireless transmitters provided in the analog operation device.

13. The system of claim 10, wherein sliding members for sliding of the analog operation device on the touch screen are formed on the analog operation device.

14. The system of claim 13, wherein the sliding members include elastic latches that are mounted on the sides of the touch screen and make the analog operation device movable.

15. The system of claim 10, further comprising:
protrusions formed on the sides of the analog operation device, and
guide grooves formed on the sides of the touch screen that guide the protrusions on the analog operation device to make the analog operation device movable.

16. The system of claim 10, further comprising:
guide grooves formed on the sides of the analog operation device, and
protrusions formed on the sides of the touch screen, the protrusions being inserted in the guide grooves on the analog operation device to guide the analog operation device so that the analog operation device is movable.

17. The system of claim 10, wherein protrusion patterns for identifying specific analog operation devices on the touch screen are formed on the bottom of the analog operation device.

18. The system of claim 10, wherein a protrusion allowing a user to recognize an operation, when the user operates the contact portion, is formed on the contact portion of the analog operation device.
